(19) United States
(12) Patent Application Publication
(10) Pub. No.: US 2004/0201554 A1
(43) Pub. Date: Oct. 14, 2004

(54) Method of driving display panel and drive for carrying out same

(76) Inventor: Shinichi Satoh, Tokyo (JP)

Correspondence Address: VOLENTINE FRANCOS, PLLC, Suite 150, 12200 Sunrise Valley Drive, Reston, VA, 20191, US

(21) Appl. No.: 10/669,446

(22) Filed: Sep. 25, 2003

(30) Foreign Application Priority Data
Apr. 10, 2003 (JP) 106985/2003

(51) Int. Cl. G09G 3/30

(52) U.S. Cl. 345/76

(57) ABSTRACT

A drive of a display panel, according to the invention, comprises first switching means SEGₘ for changing over between connection of the respective data lines SWsm to the side of respective variable current sources and connection thereof to a grounding side, second switching means SWc2 for changing over a potential of the respective scanning lines between a power supply potential V_{C} and a grounding potential, a drive control circuit for controlling the first switching means and second switching means correspondingly to input data, a comparison circuit provided in each of the data lines, for outputting a control signal by comparing a potential from a voltage regulator with a potential of the respective data lines, and a current control circuit for controlling a current of the variable current source provided in each of the data lines based on results of comparison executed by the respective comparison circuit.

### FIELD OF THE INVENTION

The present invention relates to a method of driving a panel display and a drive for carrying out the method, and in particular, to a method of driving an organic EL panel, and a drive for carrying out the method.

### BACKGROUND OF THE INVENTION

As shown in FIG. 1A, a driving circuit of an organic EL panel generally has a constant current source 11 and switching means SWₛ₁-SWₛₘ, respectively, for every data line, and a cathodic power supply potential V_{C} and switching means SW_{c1}-SW_{cn}, respectively, for every scanning line, against the organic EL panel having an organic EL element PE_{m,n}, disposed at respective crossover points of a plurality of the data lines (anodic lines SEG₁-SEGₘ) and a plurality of the scanning lines (cathodic lines COM₁-COMₙ). These switching means are controlled by a drive control circuit 10 and can be turned into select state or unselect state, respectively.

In common operation to cause the organic EL panel to emit light for displaying, the switching means SW_{cn} of the respective scanning lines COMₙ is turned ON (connected to a grounding potential V_{G}) and OFF (connected to the cathodic power supply potential V_{C}) in such a manner as to have operation waveforms shown in FIG. 2 at a predetermined time interval, thereby sequentially selecting panel rows to be lighted. At this time, the switching means SWsm of the data line SEGₘ connected to the organic EL element PE_{m,n} to be lighted, in the panel row selected, is turned ON, and current is supplied thereto, whereupon the organic EL element PE_{m,n} is caused to emit light.

Since emitted light luminance of the organic EL element PE_{m,n} is dependent on a current value, values of current supplied to the respective data lines SEGₘ are required to be constant values equal to each other in order to avoid display unevenness.

In order to obtain a constant current, it is desirable that the driving circuit is under small effects of its dependency on an output voltage of the constant current source, a power supply voltage, manufacturing variations in constituent elements thereof, or so on.

A common structure of the organic EL element is as shown in FIG. 1B. Because a transparent, electrically conductive film (ITO film) as a constituent member thereof has resistance as large as about 10 to 20 Ω/•, the same is used on the side of the anodic data lines SEGₘ where a large current does not flow (on the order of several hundred μA to 1 mA) while a resistance material such as Al is used on the side of the cathodic scanning lines COMₙ.

However, when causing all the elements in panel rows to emit light, a large current of several tens of mA flows in the direction of the grounding potential V_{G} in the scanning lines COMₙ via the switching means SW_{c1}-SW_{cn}.

Even in the case of the scanning lines COMₙ using a resistance material such as an Al cathodic wiring, there flows a large current corresponding to the panel element connected thereto and a current value necessary for light emission, so that a voltage applied to the panel element PE_{m,n} positioned at a more distal end in relation to the grounding potential V_{G} becomes very high.

Assuming that resistance of the scanning lines COMₙ is R_{m,n}, a current flowing through the resistance is I_{cm,n}, ON resistance of the switching means SW_{cn} is SWᵣₙ, and a voltage applied to the organic EL element PE_{m,n} when all the panel elements emit light is V_{m,n} as shown in FIG. 3, the following equation results:

V_{m,n}=V_{C}+SWᵣₙ*I_{c1,n}+R_{1,n}*I_{c1,n}+R_{2,n}*I_{c2,n}+ . . . +R_{m,n}*I_{cm,n}

Herein, assuming that light-emitting display panel rows are 128 rows, resistance between the panel elements is R_{m,n}=r (Ω), and a current supplied to respective data lines SEGₘ is Im=i (A), the following equation results:

$$\begin{matrix}{V}_{m , n} = {V}_{C} + {SW}_{rn} * 128 i + r * 128 i + r * 127 i + r * 126 i + … + ri \\ = {V}_{C} + {SW}_{rn} * 128 i + 8256 ri\end{matrix}$$

That is, there occurs a potential as high as 8256 ri (V) owing to the resistance component of the scanning lines COMₙ.

Thus, since the farther from the grounding potential V_{G} the EL element PE_{m,n} is positioned at a distal end, the smaller a potential difference ΔV11 applied to the respective constant current sources 11 becomes, there have been cases where it becomes impossible to supply a constant current, depending on conditions such as dependency of the respective constant current sources 11 on output voltage, a constant current value, and a drive power supply voltage Vₛ.

Further, there is a tendency of an increase in the number of bits of a driver IC following an increase in the size of a panel screen, and such an increase in the number of the bits poses a problem in that not only deterioration in display unevenness, due to manufacturing variations, is brought about but also constant current characteristic dependent on resistance on the panel described above becomes susceptible to occurrence of faults.

### SUMMARY OF THE INVENTION

The invention has been developed to resolve the problems encountered in the past, and it is an object of the invention to provide a method of driving a display panel, capable of preventing light emission faults from occurring to a panel by implementing stable supply of a constant current, and a drive for carrying out the method.

The invention provides in its first aspect a method of driving a display panel made up of (n×m) pieces of display elements each disposed at respective crossover points of a matrix, formed of n rows of scanning lines and m columns of data lines, wherein a current value of respective variable current sources for driving the respective data lines is controlled by comparing a potential of the respective data lines with a reference potential and based on results of such comparison.

Further, in accordance with a second aspect of the invention, there is provided a drive of a display panel comprising means for assuming during a display period of present display data a current correction value for each of the data lines in a succeeding display period on the basis a position of the date line, the number of the display elements, and a fixed value determined by the position of the date line, and current correction means for correcting a current value of the respective variable current sources on the basis of results of such assumption.

### BRIEF DESCRIPTION OF THE DRAWINGS

FIG. 1A is a circuit diagram for illustrating a conventional technology;

FIG. 1B is a schematic representation showing the construction of an organic EL element by way of example;

FIG. 2 is a waveform chart showing driving operation of a panel;

FIG. 3 is a circuit diagram for illustrating problems encountered by conventional technology;.

FIG. 4 is a circuit diagram of a drive of a display panel, according to a first embodiment of the invention;

FIG. 5 is a circuit diagram of a drive of a display panel, according to a second embodiment of the invention;

FIG. 6 is a detailed circuit diagram showing a variable current source 12, current control circuit 15m, and the periphery thereof, according to the first embodiment of the invention; and

FIG. 7 is a detailed circuit diagram showing a variable current source 12, current correction circuit 18m, and the periphery thereof, according to the second embodiment of the invention.

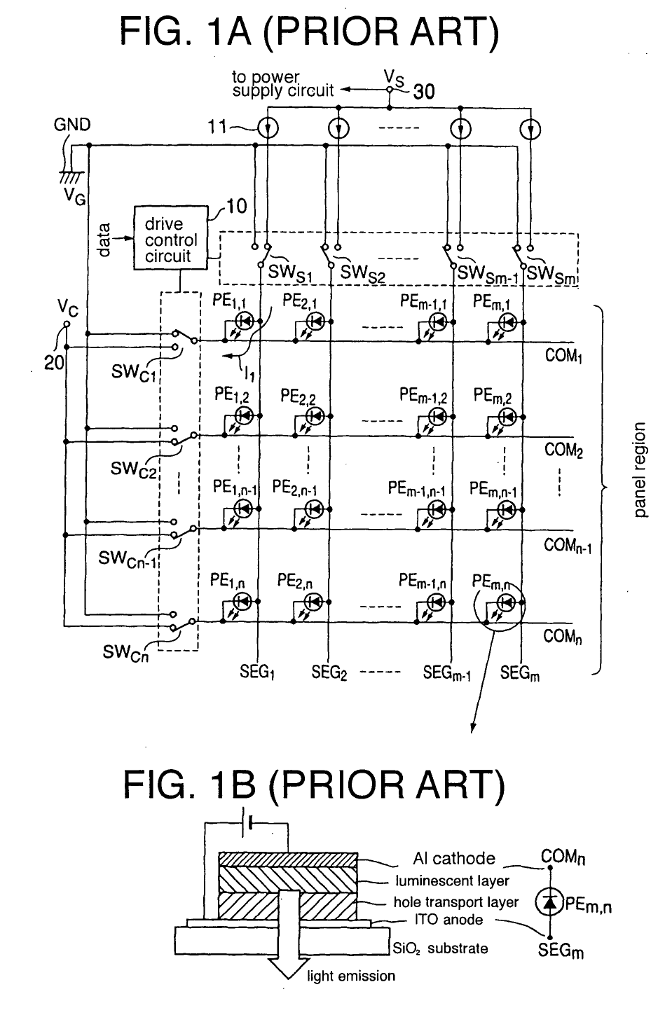

### PREFERRED EMBODIMENTS OF THE INVENTION

Embodiments of the invention are described in detail hereinafter with reference to the accompanying drawings.

First Embodiment

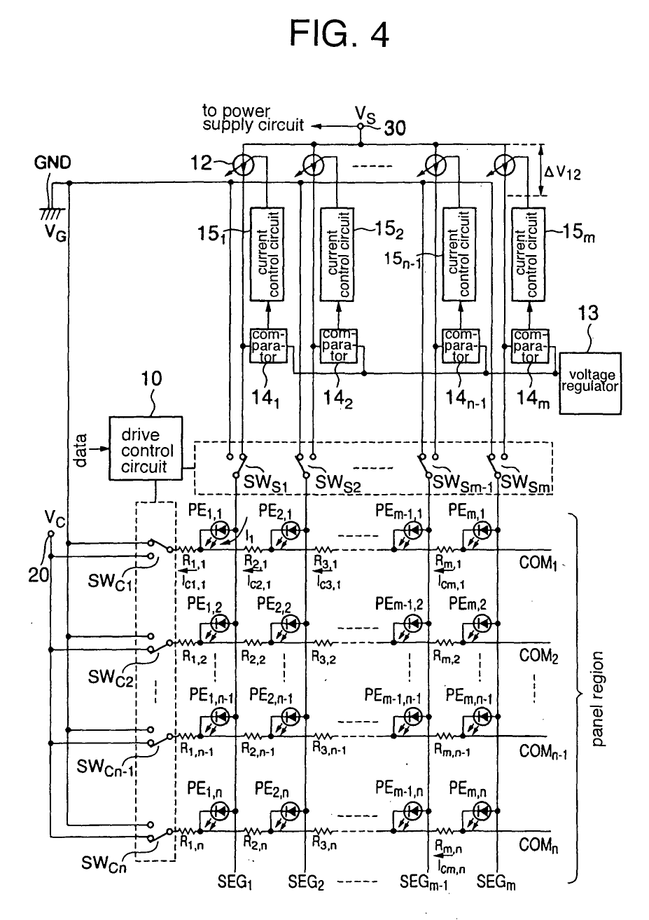

FIG. 4 is a circuit diagram of a drive of a display panel, according to a first embodiment of the invention. As shown in the figure, a comparator 14m capable of comparing voltage levels with each other is connected to respective data lines SEGₘ. The respective comparators 14m are connected to a voltage regulator 13 for generating a reference voltage. An output of the respective comparators 14m is connected to respective current control circuits 15m for controlling respective variable current sources 12. Assuming that current variation occurs when a voltage applied to the respective variable current sources 12 is ΔV12, the reference voltage of the voltage regulator 13 is set to a power supply voltage Vs-ΔV12. The respective comparators 14m are made up of a differential amplifier.

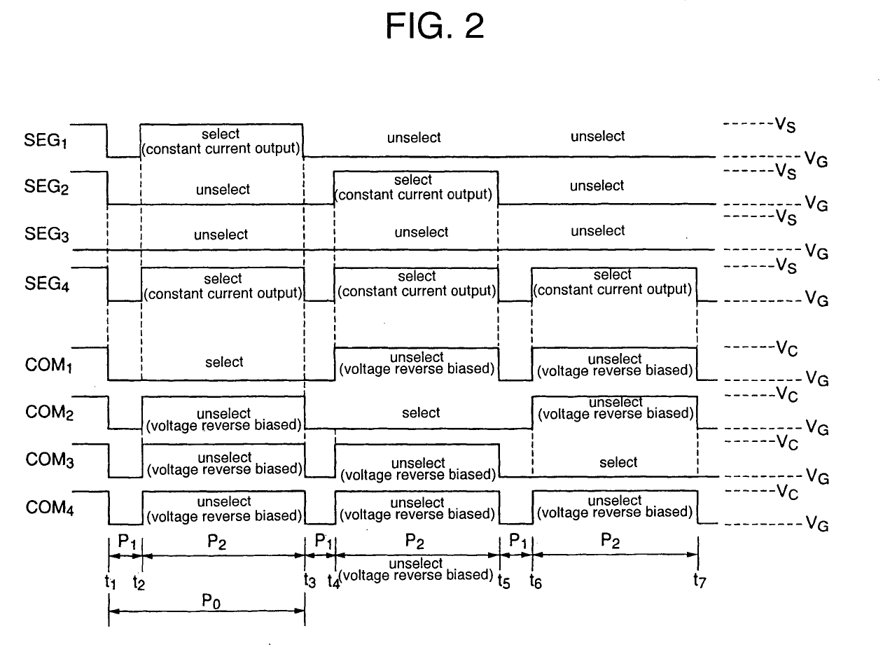

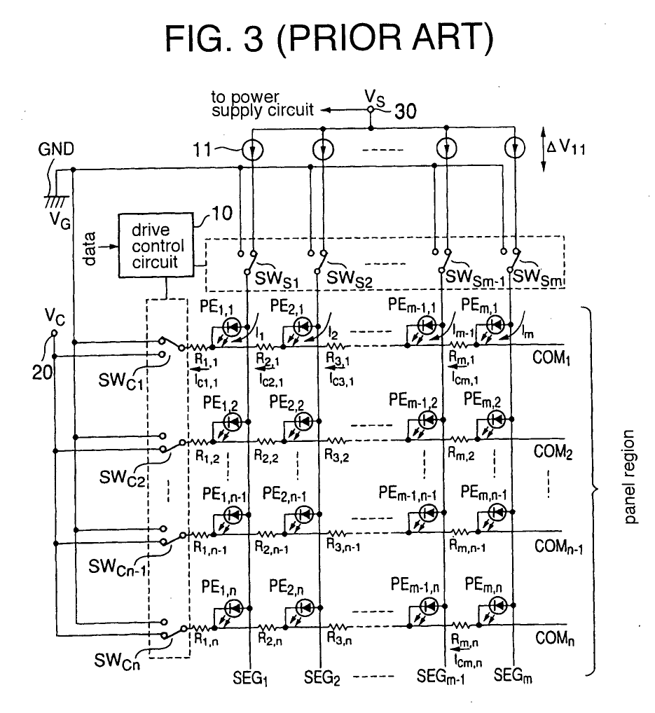

Operation of the circuit of a configuration as described above is described hereinafter. Normal operation to cause the panel to emit light for displaying is executed by turning switching means SW_{cn} of respective scanning lines COMₙ ON (connected to a grounding potential V_{G}) and OFF (connected to a cathodic power supply potential V_{C}) in such a manner as to have operation waveforms shown in FIG. 2 at a predetermined time interval, thereby sequentially selecting panel rows to be lighted. At this time, switching means SWsm of the data line SEGₘ connected to a panel element PE_{m,n} to be lighted, in the panel row selected, is turned ON, and current is supplied thereto, whereupon the panel element PE_{m,n} is caused to emit light.

At this time, a current at as large as several ten mA flows through the respective scanning lines COMₙ in the direction of the grounding potential V_{G} via the switching means SW_{cn1}-SW_{cn}, respectively. Accordingly, a voltage applied to the panel element PE_{m,n} disposed at a distal end from the grounding potential V_{G} becomes very high.

Assuming that resistance of the scanning line COMₙ is R_{m,n}, a current flowing through the resistance is Icm,n, ON resistance of the switching means SW_{cn} is SWᵣₙ, ON resistance of the switching means SWsm is SWᵣₘ and a voltage applied to the organic EL element PE_{m,n} when the panel in whole emits light is V_{m,n}, the following equation results:

V_{m,n}=V_{C}+SWᵣₙ*I_{c1,n}+R_{1,n}*I_{c1,n}+R_{2,n}*I_{c2,n}+ . . . +R_{m,n}*I_{cm,n}+SWᵣₘ*I_{cm,n}

so that when the applied voltage V_{m,n} of the respective data lines SEGₘ becomes higher than an output voltage of the voltage regulator 13, a decrease in current is detected by the respective comparators 14m made up of the differential amplifier, thereby increasing current of the respective variable current sources by the agency of the respective current control circuits 15m.

Further, when an excessive increase in current causes the voltage to drop, and V_{m,n} becomes lower than the output voltage of the voltage regulator 13, an increase in current is detected by the respective comparators 14m, thereby decreasing the current of the respective variable current sources by the agency of the respective current control circuits 15m.

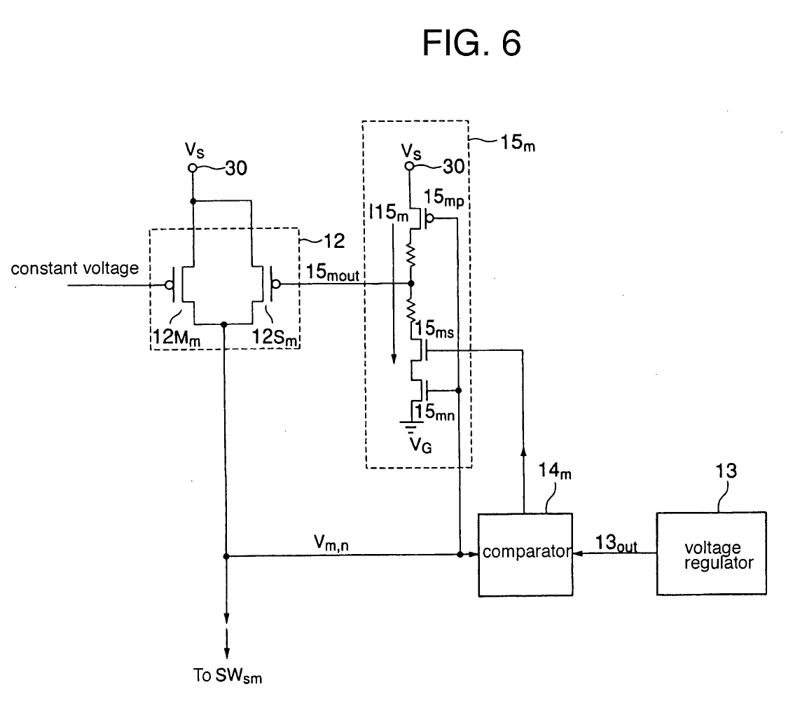

FIG. 6 is a detailed circuit diagram showing the variable current source 12, the current control circuit 15m, and the periphery thereof. The variable current source 12 comprises a PMOS transistor 12Mm for supplying a constant current at the time of normal constant current operation and a transistor 12Sm for adjustment of the constant current. The PMOS transistor 12Mm generates the constant current by applying a constant voltage to the gate thereof.

The current control circuit 15m comprises an NMOS transistor switch 15ms, an NMOS resistance 15mn with the gate thereof connected to the data line voltage V_{m,n} in common with the gate of a PMOS resistance 15mp, and other resistances, and an output 15 mout of the current control circuit 15m is set such that when the switch 15ms is ON, the transistor 12Sm can supply necessary current corresponding to the data line voltage V_{m,n} (A resistance ratio of the current control circuit 15m is set such that the transistor 12Sm for current adjustment operates in a liner region when it is within a range of the voltage V_{m,n}, requiring current adjustment. The output 15mout is changed by the NMOS resistance 15mn and PMOS resistance 15mp changing respective resistance values correspondingly to the voltage V_{m,n}, thereby adjusting a current value of the PMOS transistor 12Sm).

When the voltage V_{m,n} of the data line SEGₘ becomes higher than an output voltage 13out of the voltage regulator 13 (that is, when a voltage between the source and drain of the PMOS transistor 12Mm becomes lower, resulting in a decrease of current), the decrease of current is detected by the comparator 14m made up of the differential amplifier. The comparator 14m turns ON the NMOS transistor switch 15ms of the current control circuit 15m, whereupon a current 115m flows in the current control circuit 15m, and the output voltage 15mout of the current control circuit 15m becomes lower, so that the PMOS transistor 12Sm of the variable current source 12 is turned into ON state, thereby increasing the current of the variable current source 12.

Thus, since the current can be increased or decreased by detecting variation in current, due to insufficiency in potential applied to the current source, the present embodiment is effective for reducing light emission faults of the panel.

Second Embodiment

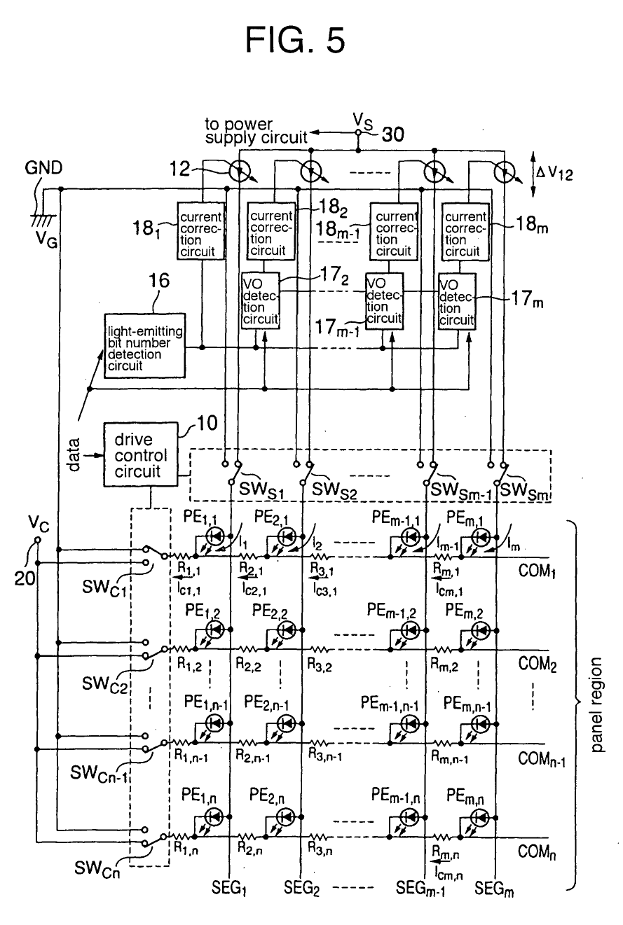

FIG. 5 is a circuit diagram of a drive of a display panel, according to a second embodiment of the invention. As shown in FIG. 5, there is provided a light-emitting bit number detection circuit 16 (which can be made up of, for example, an adder) for detecting the number of light-emitting bits for a succeeding light-emitting period on the basis of data determining light-emission and non light-emission of respective panel elements. Further, there is provided a VO detection circuit 17m (which can be made up of, for example, a subtracter and an adder) for assuming and detecting a level of a voltage applied to the panel element for each of data lines SEGₘ and the respective VO detection circuits 17m are connected with the light-emitting bit number detection circuit 16. The respective VO detection circuits 17m are connected to respective current correction circuits 18m so as to be able to control current of respective variable current sources 12. The respective current correction circuits 18m are preset so as to be able to execute current correction by stages (for example, for every 10 μA) taking into account a voltage ΔV12 applied to the respective variable current sources 12, a panel resistance value, and dependency thereof on a constant current value.

Operation of the circuit of the drive in FIG. 5 is described hereinafter. Normal operation to cause a panel to emit light is executed by turning switching means SW_{cn} of respective scanning lines COMₙON (connected to a grounding potential V_{G}) and OFF (connected to a cathode power supply potential V_{C}) in such a manner as to have operation waveforms shown in FIG. 2 at a predetermined time interval, thereby sequentially selecting panel rows to be lighted. Switching means SWsm of the data line SEGₘ connected to a panel element PE_{m,n} to be lighted, in the panel row selected, is turned ON, and current is supplied thereto, whereupon the panel element PE_{m,n} is caused to emit light.

Display data in a display period between time t4 and t5 are normally transferred in a period between time t2 and t3 and are latched before stored in a register, and the light-emitting bit number detection circuit 16 detects the number d of display elements in a subsequent display period from the display data. The respective VO detection circuits 17m assume and detect a voltage generated depending on panel resistance for each of the data lines on the basis of the display data.

Assuming that, for example, in case all m bits emit light (d=m) as shown in FIG. 5, resistance of the scanning line COM₁ formed of a conductor film, up to the data line SEG₁, is R_{1,1}, a constant current flowing through the respective data lines is I, a voltage applied to the panel element PE_{1,1}, across the resistance, is V_{1,1}, a current proportional to the number d of the display elements flows through R_{1,1}. That is, V_{1,1}=R_{1,1}*m*I.

Similarly, the following equations result:

V_{2,1}=V_{1,1}+R_{2,1}*(m−1)*I.

V_{3,1}=V_{2,1}+R_{3,1}*(m−2)*I.

V_{4,1}=V_{3,1}+R_{4,1}*(m−3)*I

V_{5,1}=V_{4,1}+R_{5,1}*(m−4)*I

Assuming that resistance R_{m,n} between the respective data lines is all identical, the following equation results:

V_{1,1}=α*m(α is a constant).

Similarly, the following equations result:

V_{2,1}=α*(2m−1)

V_{3,1}=α*(3m−3)

V_{4,1}=α*(4m−6)

V_{5,1}=α*(5m−10)

Accordingly, only a value A found from V_{m,n}=α*A is sufficient for detection by the respective VO detection circuits 17m.

If the value A of any of the data line SEGₘ becomes higher than a level value B (the value B is a value pre-calculated from the voltage ΔV12 applied to the respective variable current sources 12, a panel resistance value, and the dependency on the constant current value) set in the current correction circuit 18m, the current is increased by +10 μA by the agency of the current correction circuit 18m. Further, if the value A of the data line SEGₘ becomes higher than a level value C set in the current correction circuit 18m, the current is further increased by +10 μA (20 μA in total) by the agency of the current correction circuit 18m.

Thus, current correction to be made for a succeeding display period is determined during a preceding display period, thereby enabling a current as desired to be applied immediately upon start of a display period.

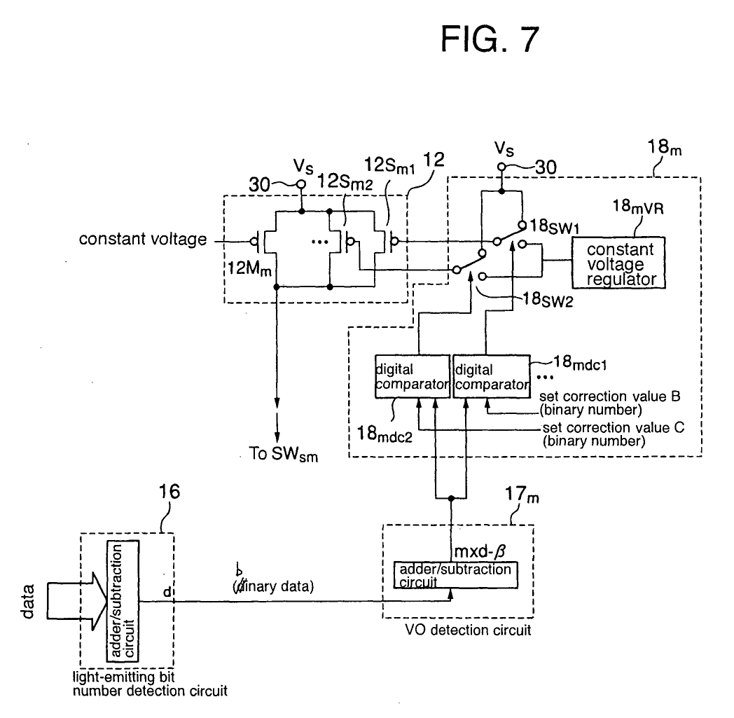

FIG. 7 is a detailed circuit diagram showing the variable current source 12, the current correction circuit 18m, and the periphery thereof. The variable current source 12 comprises a current source PMOS transistor 12Mm for supplying the constant current at the time of normal constant current operation and PMOS transistors 12Sm1, 12Sm2, for adjustment of the constant current. The current source PMOS transistor 12Mm generates the constant current by applying a constant voltage to the gate thereof.

The current correction circuit 18m comprises a plurality of digital comparators 18mdc1, 18mdc2 . . . , thereby presetting correction levels B, C, . . . , respectively. Respective outputs of the digital comparators control switching circuits 18_{SW1}, 18_{SW2}, . . . , respectively, thereby changing over respective voltages of the PMOS transistors 12Sm1, 12Sm2 of the variable current source 12 between a power supply voltage Vs and an output voltage of a constant voltage regulator 18mvr. The constant voltage regulator 18mvr outputs the voltage for controlling the PMOS transistors 12Sm1, 12Sm2, respectively. This control voltage is set so as to enable, for example, the PMOS transistor 12Sm1 to allow a current of 10 μA to flow therethrough.

The VO detection circuits 17m each are provided with an adder-subtractor, executing binary calculation. If a display position corresponds to an m-th bit from the side of the switching means SW_{cn1}-SW_{cn}, the following calculation is made based on the number d (binary number) of bits, as detected by the light-emitting bit number detection circuit 16:

A=m*d−β(β is a fixed value determined by m)

If, for example, a value A of any of the data lines SEGₘ becomes larger than the level value B as set in the current correction circuit 18m (that is, it is determined that the voltage V_{m,n} of the data line SEGₘ as calculated from the number of the light-emitting elements causes the constant current to decrease), the switching circuit 18_{SW1} is changed over by the comparator 18_{mdc1}, and the constant voltage regulator 18mVR operates such that the output voltage thereof controls the gate of the PMOS transistors 12Sm1, thereby outputting the constant current.

If the value A of the data line SEGₘ becomes larger than the level value C as set in the current correction circuit 18m (that is, it is determined that the voltage V_{m,n} of the data line SEGₘ calculated from the number of the light-emitting elements causes the constant current to further decrease), the switching circuit 18_{SW2} is changed over by the comparator 18_{mdc2}, and the constant voltage regulator 18ₘᵥᵣ operates such that the output voltage thereof controls the gate of the PMOS transistors 12Sm2, and a current is further added to the current described above, thereby outputting the constant current.

Thus, since current can be increased by pre-assuming a decrease in current, due to the panel resistance, and detecting the same, it is possible to implement not only stable supply of current during the display period, but also fine adjustment of the current, so that the present embodiment is more effective for reducing light emission faults of the panel.

What is claimed is:

1. A method of driving a display panel made up of (n×m) pieces of display elements each disposed at respective crossover points of a matrix, formed of n rows of scanning lines and m columns of data lines, said method comprising the step of variably controlling a constant current value for driving the respective data lines.

2. The method of driving a display panel according to claim 1, wherein the step of variably controlling the constant current value is implemented by comparing a voltage of the respective data lines with a reference voltage.

3. The method of driving a display panel according to claim 1, wherein the step of variably controlling the constant current value is implemented by making an assumption on a current correction value for each of the data lines in a succeeding display period during a display period of present display data.

4. The method of driving a display panel according to claim 3, wherein if a cathode of the respective display elements is connected to the respective scanning lines, and a node thereof is connected to the respective data lines, the assumption on the current correction value for a data line positioned at an m-th bit is made on the basis of a value A found by A=m*d−β, using the number d of display elements in the present display data, and a constant β determined by the m.

5. The method of driving a display panel according to claim 4, wherein the assumption on the basis of the value A is made by finding a voltage V of a data line corresponding to the m-th bit of a cathodic line, in a succeeding display period, from V=α*A where α is a constant.

6. The method of driving a display panel according to claim 1, wherein the display elements are organic EL elements.

7. A drive of a display panel for driving (n×m) pieces of display elements each disposed at respective crossover points of a matrix, formed of n rows of scanning lines and m columns of data lines, having an anode thereof, connected to the respective data lines and a cathode thereof, connected to the respective scanning lines, said drive comprising:
first switching means for changing over between connection of the respective data lines to the side of respective variable current sources and connection thereof to a grounding side;
second switching means for changing over a potential of the respective scanning lines between a power supply potential and a grounding potential;
driving means for controlling the first switching means and second switching means correspondingly to input data;
comparison means provided in each of the data lines, for outputting a control signal by comparing a reference voltage from reference voltage generation means with a potential of the respective data lines, and
current control means for controlling a current of the variable current source provided in each of the data lines based on results of comparison executed by the respective comparison means.

8. The drive of a display panel according to claim 7, wherein the comparison means detect a decrease in current of the respective variable current sources on the basis of an increase in potential of the respective data lines to thereby control so as to increase the current of the respective variable current sources, and detect an increase in the current of the respective variable current sources on the basis of a drop in the potential of the respective data lines to thereby control so as to decrease the current of the respective variable current sources.

9. A drive of a display panel for driving (n×m) pieces of display elements each disposed at respective crossover points of a matrix, formed of n rows of scanning lines and m columns of data lines, having an anode thereof, connected to the respective data lines and a cathode thereof, connected to the respective scanning lines, said drive comprising:
first switching means for changing over between connection of the respective data lines to the side of respective variable current sources and connection thereof to a grounding side;
second switching means for changing over a potential of the respective scanning lines between a power supply potential and a grounding potential;
driving means for controlling the first switching means and second switching means correspondingly to input data;
detection means for detecting the number of the display elements for each of the scanning lines in a succeeding display period on the basis of the input data;
assumption means for assuming a voltage of the data line for each of the data lines on the basis of the input data and the number of the display elements; and
current correction means for correcting a current value of the respective variable current sources on the basis of results of respective comparison means for comparing the voltage of the respective data lines as assumed with a predetermined reference voltage.

10. The drive of a display panel according to claim 9, wherein the predetermined reference voltage and the comparison means are provided in plural numbers, a plurality of comparison signals from the comparison means are delivered in response to the voltage of the respective data lines, and the current value of the respective variable current sources is controlled on the basis of the plurality of the comparison signals.

11. The drive of a display panel according to claim 7, wherein the display elements are organic EL elements.

12. A drive of a display panel for driving (n×m) pieces of display elements each disposed at respective crossover points of a matrix, formed of n rows of scanning lines and m columns of data lines, having an anode thereof, connected to the respective data lines and a cathode thereof, connected to the respective scanning lines, said drive comprising:
first switching means for changing over between connection of the respective data lines to the side of respective variable current sources and connection thereof to a grounding side;
second switching means for changing over a potential of the respective scanning lines between a power supply potential and a grounding potential;
a drive control circuit for controlling the first switching means and second switching means correspondingly to input data;
a comparator provided in each of the data lines for outputting a control signal by comparing a reference voltage from a voltage regulator with a potential of the respective data lines; and
a current control circuit for controlling a current of the variable current source provided in each of the data lines on the basis of results of comparison by the respective comparators.

13. The drive of a display panel according to claim 12, wherein the comparator detects a decrease in the current of the respective variable current sources on the basis of an increase in the potential of the respective data lines to thereby control so as to increase the current of the relevant variable current source, and the comparator detects an increase in the current of the variable current sources on the basis of a drop in the potential of the respective data lines to thereby control so as to decrease the current of the relevant variable current source.

14. A drive of a display panel for driving (n×m) pieces of display elements each disposed at respective crossover points of a matrix, formed of n rows of scanning lines and m columns of data lines, having an anode thereof, connected to the respective data lines and a cathode thereof, connected to the respective scanning lines, said drive comprising:
first switching means for changing over between connection of the respective data lines to the side of respective variable current sources and connection thereof to a grounding side;
second switching means for changing over a potential of the respective scanning lines between a power supply potential and a grounding potential;
a drive control circuit for controlling the first switching means and second switching means correspondingly to input data;
a light-emitting bit number detection circuit for detecting the number of the display elements for each of the scanning lines, in a succeeding display period on the basis of the input data;
a VO detection circuit for assuming a voltage of the data line, for each of the data lines, in the succeeding display period on the basis of the input data and the number of the display elements; and
a current correction circuit for correcting a current value of the respective variable current sources on the basis of results of a digital comparator for comparing the voltage of the respective data lines as assumed with a predetermined reference voltage.

15. The drive of a display panel according to claim 14, wherein the predetermined reference voltage and the digital comparator are provided in plural numbers, respectively, a plurality of comparison signals from the digital comparators are delivered correspondingly to the voltage of the respective data lines, and the current value of the respective variable current sources is controlled on the basis of the plurality of the comparison signals.
